(19) United States
(12) Patent Application Publication
(10) Pub. No.: US 2022/0002479 A1
(43) Pub. Date: Jan. 6, 2022

(54) METHOD FOR CRYSTALLIZING A POLYESTER COMPRISING AT LEAST ONE 1,4:3,6-DIANHYDROHEXITOL UNIT

(71) Applicant: ROQUETTE FRERES, Lestrem (FR)

(72) Inventors: Nicolas JACQUEL, LAMBERSART (FR); René SAINT-LOUP, LOMME (FR); Audrey DAUSQUE, HOUPLINES (FR); Nicolas DESCAMPS, SAINGHIN-EN-MELANTOIS (FR); Hélène AMEDRO, BETHUNE (FR); Nicolas CAIVEAU, LE PONTET (FR); Sébastien NAUDIN, COUTANCES (FR)

(21) Appl. No.: 17/281,445

(22) PCT Filed: Sep. 30, 2019
(86) PCT No.: PCT/FR2019/052307

§ 371 Date: Mar. 30, 2021

(30) Foreign Application Priority Data
Oct. 1, 2018 (FR) 18 59047

(51) Int. Cl. C08G 63/672; C08G 63/80; C08G 63/88; C08K 13/02

(52) U.S. Cl. CPC C08G 63/672; C08G 63/80; C08K 3/36; C08K 13/02; C08G 2250/00; C08G 63/88

(57) ABSTRACT

The invention relates to the field of polymers and relates to a process for crystallizing polyester. More particularly, this is a crystallization process comprising a step of provision of a polyester comprising at least one 1,4:3,6-dianhydrohexitol unit, a step of provision of a coalescence-preventing additive, and a step of crystallization of said semicrystalline polyester. The process according to the invention makes it possible to greatly limit, indeed even to eliminate, the phenomenon of agglomeration of the polyester granules during the crystallization.

### FIELD OF THE INVENTION

The invention relates to the field of polymers and very particularly relates to a process for crystallizing polyester comprising 1,4:3,6-dianhydrohexitol units.

### TECHNICAL BACKGROUND OF THE INVENTION

Polyethylene terephthalate (PET) is a widely used plastic and there are many industrial applications. However, under certain conditions of use or for certain specific applications, this polyester does not necessarily have all of the properties required. This is why glycol-modified PETs (PETgs) have been developed. These are generally polyesters comprising, in addition to the ethylene glycol and terephthalic acid units, cyclohexanedimethanol (CHDM) units. The introduction of this diol into the PET enables it to adapt the properties to the intended application, for example to improve its impact strength or its optical properties.

For essentially ecological reasons, plastics resulting from petrochemistry are less and less popular and new solutions have started to emerge.

Renewable sources have thus appeared in thermoplastic polymers and other modified PETs have been developed by introducing 1,4:3,6-dianhydrohexitol units, especially isosorbide, into the polyester. These modified polyesters have higher glass transition temperatures than conventional PET (Tg=75-80° C.) or PETgs comprising CHDM (Tg=75-85° C.) and hence have improved thermomechanical properties. In comparison, the glass transition of copolyesters of PET containing isosorbide can range up to 210° C. Polyesters comprising isosorbide units are polyesters eligible for the manufacture of many speciality products.

Conventionally, polyesters are obtained via the melt route, but this technique does not make it possible to achieve the high molar masses (>16 000 g/mol) required for applications requiring high mechanical properties or high melt viscosities necessary for their transformation.

Thus, higher molar masses can be obtained by means of a particular process, namely solid-state post-condensation of the polymer, and in particular of the polyester. By way of example, this is generally the process employed to obtain fiber-grade or bottle-grade polyesters. That is to say, polyesters meeting the quality criteria imposed by the industrial standards for fiber or bottle manufacture.

In general, solid-state post-condensation is carried out in two phases. In a first phase, the polyester granules are crystallized under a stream of nitrogen or under vacuum at a temperature close to the optimal crystallization temperature of the polyester concerned. The point of the crystallization is to avoid the agglomeration of the granules at high temperature and to concentrate the ends of the chains in the amorphous domains.

Once crystallized, the granules are then heated in a second phase to a higher temperature in order to carry out the solid-state post-condensation proper, generally between 5° C. and 20° C. below the melting point of the polymer. This step makes it possible to increase the molar mass of the polymer. The pressures thus used are less than 10 mbar absolute, and generally close to 5 mbar absolute.

For most polyesters, under these conditions, the crystallization step does not present any particular problem. Industrially, PET is crystallized either in a fluidized bed or in a sufficiently agitated rotary drum. This makes it possible to avoid coalescence of the granules. Nevertheless, polyesters comprising 1,4:3,6-dianhydrohexitol units have a greater tendency to agglomerate than PET.

Application WO 2016/189239 Al describes a process for manufacturing a polyester comprising at least one 1,4:3,6-dianhydrohexitol unit, at least one alicyclic diol unit different from the 1,4:3,6-dianhydrohexitol units and at least one terephthalic acid unit. However, the Applicant has found that these polyesters containing 1,4:3,6-dianhydrohexitol units, in particular isosorbide, had the tendency to become tacky on the surface before reaching the optimum crystallization temperature. The granules tend to coalesce and stick to the walls of the crystallizer.

This phenomenon of coalescence of polyesters comprising 1,4:3,6-dianhydrohexitol units poses problems of obstruction of the processes and of manipulation of the granules, and slows the solid-state post-condensation kinetics.

There is thus a need to develop new processes making it possible to limit, or even to eliminate, the phenomenon of agglomeration of the granules which is observed during the crystallization of polyesters comprising 1,4:3,6-dianhydrohexitol units.

It is therefore to the Applicant's credit to have developed a process making it possible to limit, indeed even to eliminate, the phenomenon of coalescence of polyesters comprising 1,4:3,6-dianhydrohexitol units, in particular isosorbide, and thus to overcome the problems this generates.

### SUMMARY OF THE INVENTION

The invention relates to a process for crystallizing a polyester comprising at least one 1,4:3,6-dianhydrohexitol unit and comprising the following steps of:
provision of a semicrystalline polyester comprising at least one 1,4:3,6-dianhydrohexitol unit,
provision of a coalescence-preventing additive,
crystallization of said polyester.

The process according to the invention has the advantage of limiting, indeed even of eliminating, the phenomenon of agglomeration of the granules which is observed during the crystallization of polyesters comprising at least one 1,4:3,6-dianhydrohexitol unit.

### DETAILED DESCRIPTION OF THE INVENTION

The invention relates to a process for crystallizing a polyester comprising at least one 1,4:3,6-dianhydrohexitol unit and comprising the following steps of:
provision of a semicrystalline polyester comprising at least one 1,4:3,6-dianhydrohexitol unit,
provision of a coalescence-preventing additive,
crystallization of said polyester.

The process according to the invention thus makes it possible to obtain a crystallized polyester.

Surprisingly, the Applicant has found that the phenomenon of agglomeration of the granules which is observed during the crystallization of polyesters comprising at least one 1,4:3,6-dianhydrohexitol unit could be greatly limited, indeed even eliminated completely, when an additive was present during the crystallization.

The First Step of the Crystallization Process According to the Invention Therefore Consists in Providing a Semicrystalline Polyester Comprising a 1,4:3,6-Dianhydrohexitol Unit.

According to the present invention, the 1,4:3,6-dianhydrohexitol unit of the polyester can be isosorbide, isomannide, isoidide, or one of the mixtures thereof. Preferably, the 1,4:3,6-dianhydrohexitol unit is isosorbide.

Isosorbide, isomannide and isoidide may be obtained, respectively, by dehydration of sorbitol, of mannitol and of iditol. As regards isosorbide, it is sold by the Applicant under the brand name Polysorb® Isosorbide.

The polyester provided in this first step can be in a form conventionally used by those skilled in the art, namely for example in the form of granules.

According to one particular embodiment, the polyester used in the crystallization process according to the invention is a semicrystalline thermoplastic polyester comprising:
at least one 1,4:3,6-dianhydrohexitol unit (A),
at least one diol unit (B), which is different from the 1,4:3,6-dianhydrohexitol unit (A),
at least one aromatic dicarboxylic acid unit (C).

According to this embodiment, the 1,4:3,6-dianhydrohexitol unit (A) is as defined above.

The diol unit (B) of the thermoplastic polyester can be an alicyclic diol unit, a non-cyclic aliphatic diol unit or a mixture of an alicyclic diol unit and a non-cyclic aliphatic diol unit.

In the case of an alicyclic diol unit, also called an aliphatic and cyclic diol, this is a unit other than 1,4:3,6-dianhydrohexitol. This can be a diol selected from the group comprising 1,4-cyclohexanedimethanol, 1,2-cyclohexanedinnethanol, 1,3-cyclohexanedinnethanol, spiroglycol, tricyclo[5.2.1.0^{2,6}]decanedinnethanol (TCDDM), 2,2,4,4-tetrannethyl-1,3-cyclobutanediol, tetrahydrofurandimethanol (THFDM), furandimethanol, 1,2-cyclopentanediol, 1,3-cyclopentanediol, 1,2-cyclohexanediol, dioxane glycol (DOG), norbornanediols, adamanthanediols, pentacyclopentadecanedimethanols or a mixture of these diols. Preferably, the alicyclic diol unit is 1,4-cyclohexanedimethanol. The alicyclic diol unit (B) may be in the cis configuration, in the trans configuration, or may be a mixture of diols in the cis and trans configurations.

In the case of a non-cyclic aliphatic diol unit, it may be a linear or branched non-cyclic aliphatic diol, said non-cyclic aliphatic diol possibly also being saturated or unsaturated. A saturated linear non-cyclic aliphatic diol is for example ethylene glycol, 1,3-propanediol, 1,4-butanediol, 1,5-pentanediol, 1,6-hexanediol, 1,8-octanediol and/or 1,10-decanediol. A saturated branched non-cyclic aliphatic diol is for example 2-methyl-1,3-propanediol, 2,2,4-trinnethyl-1,3-pentanediol, 2-ethyl-2-butyl-1,3-propanediol, propylene glycol and/or neopentyl glycol. An unsaturated aliphatic diol unit is for example cis-2-butene-1,4-diol. Preferably, the non-cyclic aliphatic diol unit is ethylene glycol.

The aromatic dicarboxylic acid unit (C) is chosen from aromatic dicarboxylic acids known to those skilled in the art. The aromatic dicarboxylic acid can be a derivative of naphthalates, terephthalates, furanoates, thiophene dicarboxylate, pyridine dicarboxylate or of isophthalates, or mixtures thereof. Advantageously, the aromatic dicarboxylic acid is a terephthalate derivative and, preferably, the aromatic dicarboxylic acid is terephthalic acid.

The amounts of different units can easily be adapted by those skilled in the art to obtain a semicrystalline character. For example, a semicrystalline thermoplastic polyester can comprise:
a molar amount of 1,4:3,6-dianhydrohexitol units (A) ranging from 1 to 15 mol %;
a molar amount of alicyclic diol units (B) different from the 1,4:3,6-dianhydrohexitol units (A) ranging from 30 to 54 mol %;
a molar amount of terephthalic acid units (C) ranging from 45 to 55 mol %.

The molar amounts are expressed relative to total molar amount of said polyester.

Still according to this particular embodiment, the molar ratio of 1,4:3,6-dianhydrohexitol units (A)/sum of the 1,4:3,6-dianhydrohexitol units (A) and of the diol units (B) different from the 1,4:3,6-dianhydrohexitol units (A), i.e. (A)/[(A)+(B)], is at least 0.01 and at most 0.90. Advantageously, this ratio is at least 0.05 and at most 0.65.

According to a first variant of this particular embodiment, the diol unit (B) of the thermoplastic polyester the polyester is an alicyclic diol unit selected from the group comprising 1,4-cyclohexanedimethanol, 1,2-cyclohexanedinnethanol, 1,3-cyclohexanedinnethanol, or a mixture of these diols. Preferably, the alicyclic diol unit is 1,4-cyclohexanedinnethanol. Thus, according to this variant, the polyester is devoid of ethylene glycol.

According to a second variant of this particular embodiment, the diol unit (B) of the thermoplastic polyester the polyester is a saturated linear non-cyclic aliphatic diol selected from the group comprising ethylene glycol, 1,3-propanediol, 1,4-butanediol, 1,5-pentanediol, 1,6-hexanediol, 1,8-octanediol and/or 1,10-decanediol. Preferably, the saturated linear non-cyclic aliphatic diol is ethylene glycol.

The Second Step of the Process Consists in Providing an Additive.

The Applicant has found that the addition of a coalescence-preventing additive to the polyester comprising a 1,4:3,6-dianhydrohexitol unit in the crystallization medium in particular proportions made it possible to reduce or prevent the coalescence of the polyester granules during the crystallization. The additive is added so as to coat the polyester granules and the walls of the crystallization reactor. Thus, the additive has an anticaking function.

Advantageously, the coalescence-preventing additive is selected from inorganic additives, organic additives and polymers. The inorganic additives include minerals such as calcium silicate, nanosilica powder, talc, microtalc, kaolinite, montmorillonite, synthetic mica, calcium sulfate, boron nitride, barium sulfate, gypsite, and also inorganic oxides such as oxides and carbonates of silicon, of aluminum, of titanium, of calcium, of iron and of magnesium. The organic additives include methylene carbonate, propylene carbonate, terephthalic acid, phthalic anhydride, succinic anhydride, sodium benzoate, lithium benzoate, calcium benzoate, magnesium benzoate, barium benzoate, potassium benzoate, lithium terephthalate, sodium terephthalate, potassium terephthalate, calcium oxalate, sodium laurate, potassium laurate, sodium myristate, potassium myristate, calcium myristate, sodium octacosanoate, calcium octacosanoate, sodium stearate, potassium stearate, lithium stearate, calcium stearate, magnesium stearate, barium stearate, sodium montanate, calcium montanate, sodium toluoylate, sodium salicylate, potassium salicylate, lithium dicarbonate, sodium naphthalate, sodium cyclohexanecarboxylate, organic sulfonates, and carboxylic acid amides. The polymers include inorganic polymers such as fumed silica, optionally treated with dimethyldichlorosilane (Aerosil R972).

Preferably, the coalescence-preventing additive is chosen from talc, sodium benzoate, fumed silica, optionally treated with dimethyldichlorosilane, and terephthalic acid. More preferably, the coalescence-preventing additive is chosen from talc, sodium benzoate and terephthalic acid. Advantageously, the coalescence-preventing additive is added in a proportion of between 100 and 25 000 ppm relative to the total weight of polyester.

In a preferred embodiment, the coalescence-preventing additive is talc and is added in a proportion of between 100 and 10 000 ppm, preferably between 500 and 5000 ppm, more preferably between 1000 and 4000 ppm and more preferentially between 1500 and 3000 ppm, relative to the total weight of the polyester. More preferentially still, the talc is added in a proportion of approximately 2000 ppm relative to the total weight of the polyester.

In another preferred embodiment, the coalescence-preventing additive is sodium benzoate and is added in a proportion of between 100 and 10 000 ppm, preferably between 2000 and 9000 ppm, more preferably between 4000 and 8000 ppm and more preferentially between 6000 and 8000 ppm, relative to the total weight of the polyester. More preferentially still, the sodium benzoate is added in a proportion of approximately 7000 ppm relative to the total weight of the polyester.

In another preferred embodiment, the coalescence-preventing additive is fumed silica, optionally treated with dimethyldichlorosilane (Aerosil R972), and is added in a proportion of between 100 and 10 000 ppm, preferably between 200 and 5000 ppm, relative to the total weight of the polyester. More preferably, the fumed silica is added in a proportion of approximately 250 ppm relative to the total weight of the polyester.

In another preferred embodiment, the coalescence-preventing additive is terephthalic acid and is added in a proportion of between 10 000 and 25 000 ppm, preferably between 15 000 and 25 000 ppm, more preferably between 17 500 and 22 500 ppm, relative to the total weight of the polyester. More preferentially, the terephthalic acid is added in a proportion of approximately 20 000 ppm relative to the total weight of the polyester.

The third step of the process consists in crystallizing said polyester. Crystallization is a phenomenon in which a body, in this case polyester, passes partially into a crystal state.

The step of crystallization of the polyester is achieved by heating to the crystallization temperature. More particularly, the polyester is heated gradually following a temperature ramp up to the crystallization temperature. This temperature is then maintained for a time sufficing to allow maximum crystallization thereof.

The crystallization temperature depends on each polyester. However, it is a characteristic known and/or measurable by those skilled in the art. Thus, in the process according to the invention, the temperature used for the crystallization of the polyester is determined by those skilled in the art on the basis of differential scanning calorimetry (DSC) analyses.

Advantageously, the step of crystallization of the polyester comprising a 1,4:3,6-dianhydrohexitol unit is carried out under a pressure of at least 600 mbar absolute. Very particularly, the crystallization is carried out under a pressure of at least 700 mbar absolute, of at least 800 mbar absolute, of at least 900 mbar absolute, more still of at least 1000 mbar absolute. Starting from a pressure of 800 mbar absolute, the phenomenon of expansion of the polyester is completely eliminated.

According to a particular embodiment, the crystallization of the polyester comprising a 1,4:3,6-dianhydrohexitol unit is carried out under a pressure in the range extending from 600 mbar absolute up to atmospheric pressure.

The step of crystallization according to the invention can be carried out in the presence or absence of an inert gas stream, such as for example a stream of dinitrogen.

According to a particular embodiment, the process according to the invention also comprises a step of recovering the crystallized polyester.

According to a particular embodiment, the process according to the invention also comprises a step of increasing the molar mass. This step of increasing the molar mass can be carried out by post-polymerization of the polyester. Preferably, the post-polymerization is implemented by a solid-state post-condensation (SSP) step.

Solid-state post-condensation is carried out at a temperature between the glass transition temperature and the melting point of the polymer. Thus, in order to carry out this SSP step, it is necessary for the polyester to be semicrystalline and crystallized. Since post-condensation is a step well known to those skilled in the art, they may adjust the operating conditions depending on the polyester for which the molar mass is intended to be increased.

Consequently, the invention also relates to a process for increasing the molar mass of a semicrystalline polyester comprising at least one 1,4:3,6-dianhydrohexitol unit and comprising the following steps of:
provision of a semicrystalline polyester comprising at least one 1,4:3,6-dianhydrohexitol unit as defined above,
provision of a coalescence-preventing additive,
crystallization of said polyester,
increasing of the molar mass by solid-state post-condensation of said crystallized polyester.

Likewise, the polyester provided in the first step can be as defined above.

The coalescence-preventing additive provided in the second step can be as defined above. The additive is added so as to coat the polyester granules and the walls of the crystallization reactor. Thus, the additive has an anticaking function.

Advantageously, the presence of the coalescence-preventing additive has little impact, if any, on the kinetics of the increase of molar mass of the semicrystalline polyester comprising at least one 1,4:3,6-dianhydrohexitol unit.

According to a particular embodiment, the step of crystallization of the semicrystalline polyester comprising a 1,4:3,6-dianhydrohexitol unit is carried out under a pressure in the range extending from 600 mbar absolute up to atmospheric pressure.

According to a particular embodiment, the process for increasing the molar mass comprises a step of recovering the polyester after increasing the molar mass.

This process for increasing the molar mass is particularly advantageous in that it makes it possible to obtain semicrystalline polyesters having an increased molar mass while at the same time limiting, indeed even eliminating, the phenomenon of agglomeration of the granules of said polyester during the crystallization step. Thus, in the absence of coalescence of the granules, the polyester possesses a homogeneous macroscopic structure, which makes it possible to obtain uniform rates during the post-condensation step and hence, at the end of the process, homogeneity of the molar mass of said polyester.

The invention is also described in the figures and examples below, which are intended to be purely illustrative and do not in any way limit the scope of the present invention.

### FIGURES

FIG. 1: Change in the molar mass of Polyester 1 as a function of SSP time at 227° C. with the addition of various additives.

FIG. 2: Flexural and tensile moduli of Polyester 1 with the addition of various additives.

FIG. 3: Elongation at break of Polyester 1 with the addition of various additives.

FIG. 4: Change in the optical properties of Polyester 1 with the addition of various additives.

### EXAMPLES

In all of the examples, the wording “nnor/o/diols” refers to the mol % of isosorbide relative to the diols.

The reduced viscosity in solution (tired) is evaluated using an Ubbelohde capillary viscometer at 35° C. in an of ortho-chlorophenol after dissolving the polymer at 135° C. with magnetic stirring. For these measurements, the polymer concentration introduced is 5 g/l.

Tg: Glass transition temperature

Mp: melting point

For the illustrative examples presented below, the following reactants were used:
Isosorbide (purity >99.5%) Polysorb® P—Roquette Freres
1,4-Cyclohexanedinnethanol (99% purity, mixture of cis and trans isomers)
Terephthalic acid (purity 99-F %)—Accros
Cobalt acetate tetrahydrate (99.999%)—Sigma Aldrich
Ethylene glycol (purity>99.8%)—Sigma-Aldrich
Antioxidant: Irganox 1010—BASF SE
Antioxidant: Hostanox P-EPQ—Clariant
Irgamod 195—BASF SE
Polymerization additive for limiting etherification reactions: tetraethylammonium hydroxide as a 20% by weight solution in water—Sigma Aldrich
Germanium dioxide (>99.99%)—Sigma Aldrich
Dimethyltin oxide (99%)—Sigma Aldrich
Sodium acetate (>99%) Sigma Aldrich
Talc Imerys 00S F
Sodium benzoate (>99%) Sigma Aldrich
Fumed silica:
Fumed silica treated with dimethyldichlorosilane: Aerosil R972

Synthesis of the Polyesters

In this example, two polyesters (1 and 2) for use according to the invention were synthesized.

Polyester 1

21.05 kg of terephthalic acid, 6.4 kg of isosorbide and 13.8 kg of cyclohexanedimethanol are introduced into a 100 l reactor. Then, 12 g of dimethyltin oxide (catalyst) and 17.4 g of Irgamod 195 are also added to the paste.

The reaction mixture is then heated gradually to 250° C. under a pressure of 5 bar absolute and with constant stirring. The water formed by esterification is continuously removed during the reaction. The degree of esterification is estimated from the mass of distillate collected. After approximately 5 hours of esterification, the pressure in the reactor is reduced to atmospheric pressure and the temperature is brought to 260° C. The pressure is then reduced to 0.7 mbar absolute over 1 hour 30 minutes according to a logarithmic ramp and the temperature is brought to 280° C. After 190 minutes, the polymer is poured into a water tank and chopped in the form of cylindrical granules.

The properties of the final polyester are as follows: ηred=51.8 ml/g (35° C., 5 g/l, ortho-chlorophenol), Tg=116° C.

The polyester also has an isosorbide content measured by ¹H NMR of 25.0 mol %/diols, a mass per 100 granules=0.91 g, and a water content of 0.43%.

The granules have a diameter of 1.7±0.2 mm, and a length of 3.3±0.5 mm.

Polyester 2

29.0 kg of terephthalic acid, 3.7 kg of isosorbide and 11.4 kg of ethylene glycol are introduced into a 100 l reactor. Then, 11.6 g of germanium oxide, 2.7 g of cobalt acetate, 17.7 g of Hostanox PEPQ, 17.7 g of Irganox 1010 and 6.2 g of an aqueous solution (20% by weight) of tetraethylammonium hydroxide are also added to the paste.

The reaction mixture is then heated gradually to 250° C. under a pressure of 3 bar absolute and with constant stirring. The water formed by esterification is continuously removed during the reaction. The degree of esterification is estimated from the mass of distillate collected. After approximately 3 hours 30 minutes of esterification, the pressure in the reactor is reduced to atmospheric pressure over 15 minutes. The pressure is then reduced to 0.7 mbar absolute over 30 minutes according to a logarithmic ramp and the temperature is brought to 265° C. After 110 minutes, the polymer is poured into a water tank and chopped in the form of cylindrical granules.

The properties of the final polyester are as follows: ηred=47.7 ml/g (35° C., 5 g/l, ortho-chlorophenol), Tg=91° C.

The polyester also has an isosorbide content measured in ¹H NMR of 10.2 mol %/diols, a mass per 100 granules=1.17 g, and a water content of 0.47%.

The granules have a diameter of 1.7±0.1 mm, and a length of 3.1±0.2 mm.

Demonstration of the Absence of Coalescence During the Crystallization.

The aim of this example is to demonstrate and to evaluate the phenomenon of the absence of coalescence during a step of crystallization of a polyester containing isosorbide.

General Test Procedure:

The tests were carried out in a laboratory rotary evaporator. A 500 ml fluted round-bottom flask is immersed into an oil bath at an angle of 45° such that the part of the flask containing the granules is completely submerged when the oil is at the test temperature. The flask is stirred at 40 rpm with nitrogen inertization of 0.5 to 2 Ihnin. The polymer granules and any additives are placed into the round-bottom flask and rapidly heated to their glass transition temperature. The bath is then heated at 1° C./min up to the crystallization temperature. After crystallization, the flask is taken out of the bath to be cooled to ambient temperature. The adhesion to the wall and the agglomeration of the granules were observed throughout the tests.

### Example 1

75 g of granules of Polyester 1 are placed into the round-bottom flask with various additives: fumed silica (aggregates of 0.2 to 0.3 pm), Aerosil R972, talc, sodium benzoate or sodium stearate. The efficacy of the treatment is shown in table 1 for each test.

TABLE 1

| | | | % of granules | Presence |
|---|---|---|---|---|
| | Amount | % of granules | agglomerated | of static |
| Additive | (ppm) | in motion | on cooling | electricity |
| — | — | 0% | 5% | Yes |
| Talc | 2000 | 100% | 0% | No |
| Sodium | 7000 | 100% | 0% | No |
| benzoate | | | | |
| Fumed silica | 150 | 33% | 2% | Yes |
| Fumed silica | 250 | 100% | 0% | Yes |
| Aerosil R972 | 250 | 100% | 0% | Yes |
| Terephthalic | 20 000 | 100% | 0% | No |
| acid | | | | |

Talc, sodium benzoate and silica (fumed silica or Aerosil at 250 ppm) make it possible to crystallize the polyester 1 while eliminating the problem of agglomeration. Silica has the drawback of not eliminating the static electricity, which may pose problems with homogeneity in the kinetics of crystallization, diffusion and increase in molar mass.

### Example 2

The example was repeated with polyester 2 and the addition of certain additives: talc, sodium benzoate, fumed silica (aggregates of 0.2 to 0.3 μm) or terephthalic acid (PTA). The efficacy of the treatment is shown in table 2 for each test.

TABLE 2

| | | | % of granules | Presence |
|---|---|---|---|---|
| | Amount | % of granules | agglomerated | of static |
| Additive | (ppm) | in motion | on cooling | electricity |
| — | — | 0% | 15% | Yes |
| Talc | 2000 | 100% | 0% | No |
| Sodium | 7000 | 100% | 0% | No |
| benzoate | | | | |
| Fumed silica | 250 | 100% | 0% | Yes |
| Terephthalic | 5000 | 10% | 2% | No |
| acid | | | | |
| Terephthalic | 20 000 | 100% | 0% | No |
| acid | | | | |

The conclusions of example 1 are valid for PE₁₀T. PTA at 2000 ppm also makes it possible to eliminate the problem of agglomeration.

### Example 3

The tests of example 1 were repeated on a larger scale for the additives which work. 500 g of granules of Polymer 1 (PI₂₅Tg) were placed into a 2 l round-bottom flask. The addition of talc and sodium benzoate makes it possible to eliminate the problem of agglomeration. On the other hand, the addition of 250 ppm of fumed silica (0.2-0.3 μm) does not work as well as in example 1. Approximately 50% of the granules remain in motion throughout the crystallization, but the other half is stuck and agglomerated on cooling. The same observations as in table 1 were made for a test without additive.

### Example 4

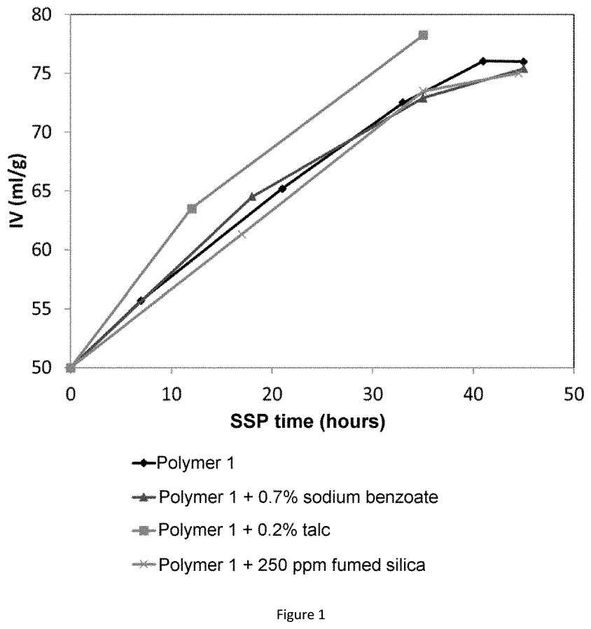

The materials obtained at the end of the tests of example 3 were used to confirm the benefit of the additives in SSP. The granules are brought to 227° C. (material temperature) for several hours with a nitrogen stream of 2 l/min and stirring at 20 rpm. The kinetics of the molar mass increases are shown in FIG. 1.

FIG. 1 shows that the addition of the anticaking agents has little impact on the SSP kinetics.

At the end of SSP, it is observed that the anticaking agent is incorporated into the polymer. There is no residual powder in the reactor.

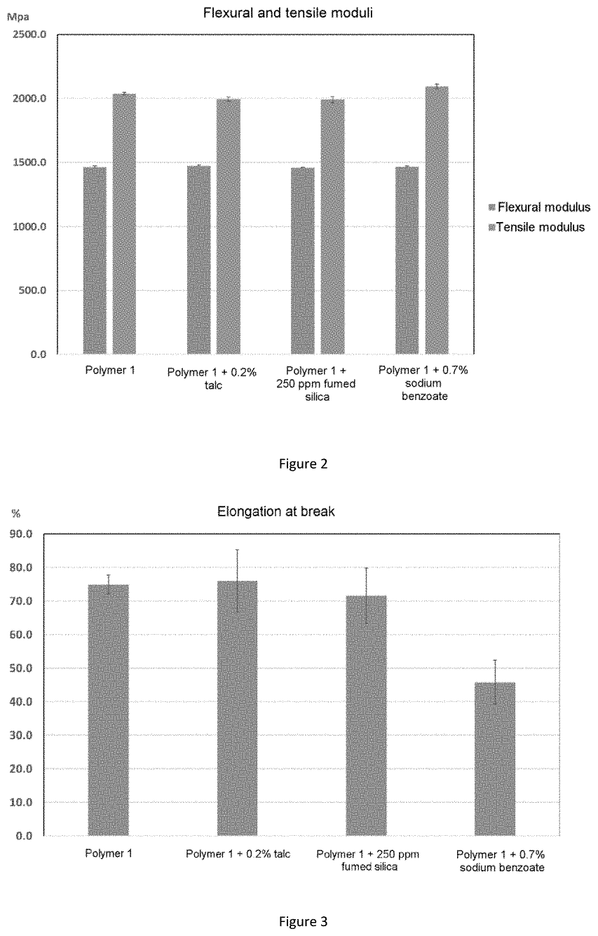

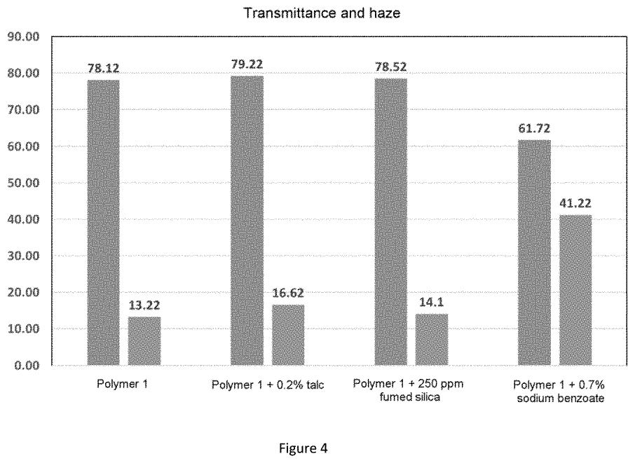

The polymers were then injection molded. The mechanical and optical characterizations of the final pieces are shown in FIGS. 2 and 3.

These figures show that the addition of talc and fumed silica do not greatly modify the mechanical and optical characteristics of the final material.

1. A process for crystallizing a polyester comprising at least one 1,4:3,6-dianhydrohexitol unit, comprising the steps of:
providing a semicrystalline polyester comprising at least one 1,4:3,6-dianhydrohexitol unit,
providing a coalescence-preventing additive, and
crystallizing said polyester.

2. The crystallization process as claimed in claim 1, wherein the coalescence-preventing additive is chosen from talc, sodium benzoate, fumed silica, optionally treated with dimethyldichlorosilane, and terephthalic acid.

3. The crystallization process as claimed in claim 1, wherein the coalescence-preventing additive is added in a proportion of between 100 and 25 000 ppm relative to the total weight of polyester.

4. The process as claimed in claim 1, wherein the 1,4:3,6-dianhydrohexitol unit is isosorbide.

5. The process as claimed in claim 1, wherein the polyester provided is a semicrystalline thermoplastic polyester comprising:
at least one 1,4:3,6-dianhydrohexitol unit (A),
at least one diol unit (B), which is different from the 1,4:3,6-dianhydrohexitol unit (A), and
at least one aromatic dicarboxylic acid unit (C).

6. The process as claimed in claim 5, wherein the diol unit (B) of said polyester, which is different from the 1,4:3,6-dianhydrohexitol unit (A), is an alicyclic diol unit selected from the group comprising 1,4-cyclohexanedimethanol, 1,2-cyclohexanedimethanol, 1,3-cyclohexanedimethanol, spiroglycol, tricyclo[5.2.1.0^{2,6}]decanedimethanol (TCDDM), 2,2,4,4-tetramethyl-1,3-cyclobutanediol, tetrahydrofurandimethanol (THFDM), furandimethanol, 1,2-cyclopentanediol, 1,3-cyclopentanediol, 1,2-cyclohexanediol, dioxane glycol (DOG), norbornanediols, adamanthanediols, pentacyclopentadecanedimethanols or a mixture of these diols, preferably 1,4-cyclohexanedimethanol.

7. The process as claimed in claim 5, wherein the diol unit (B) of said polyester, which is different from the 1,4:3,6-dianhydrohexitol (A), is a saturated linear non-cyclic aliphatic diol selected from the group comprising ethylene glycol, 1,3-propanediol, 1,4-butanediol, 1,5-pentanediol, 1,6-hexanediol, 1,8-octanediol and/or 1,10-decanediol, preferably ethylene glycol.

8. The process as claimed in claim 5, wherein the diol unit (C) of said polyester is selected from the group comprising derivatives of naphthalates, terephthalates, furanoates, thiophene dicarboxylate, pyridine dicarboxylate, of isophthalates or mixtures thereof.

9. The process as claimed in claim 1, also comprising a step of increasing the molar mass of said polyester after the crystallization step.

10. The process as claimed in claim 9, wherein the increase in molar mass of said polyester is carried out by solid-state post-condensation (SSP).

11. A process for increasing the molar mass of a polyester comprising at least one 1,4:3,6-dianhydrohexitol unit, comprising the steps of:
providing a semicrystalline polyester comprising at least one 1,4:3,6-dianhydrohexitol unit,
providing a coalescence-preventing additive,
crystallizing said polyester, and
increasing of the molar mass by solid-state post-condensation of said crystallized polyester.
